(19) United States
(12) Patent Application Publication
(10) Pub. No.: US 2015/0176960 A1
(43) Pub. Date: Jun. 25, 2015

(54) MEASURING DEVICE FOR MEASURING A THICKNESS OF A FERROMAGNETIC METAL OBJECT

(71) Applicant: Dmitriy Evgen'evich AVILOV, Saint Petersburg (RU)

(72) Inventor: Dmitriy Evgen'evich AVILOV, Saint Petersburg (RU)

(73) Assignee: OOO "Gazproekt-diagnostika", Saint Petersburg (RU)

(21) Appl. No.: 14/582,538

(22) Filed: Dec. 24, 2014

(30) Foreign Application Priority Data
Dec. 24, 2013 (EA) 201300133

(51) Int. Cl. G01B 7/06

(52) U.S. Cl. CPC G01B 7/10

(57) ABSTRACT

The invention relates to a device for measuring a thickness of ferromagnetic metal objects. The measuring device for measuring a thickness of a ferromagnetic metallic object comprises at least two measurement sensors, each of the measurement sensors comprising a core that forms a closed magnetic circuit in combination with at least a part of the ferromagnetic metal object; and a core coil in which a current pulse is formed; wherein the measuring device further comprises a determination unit for determining the time constant of an exponential voltage pulse formed in the coil as a result of forming said current pulse, and an electronic unit which is coupled to each measurement sensor and which controls said sensors.

### CROSS-REFERENCE TO RELATED APPLICATIONS

This application claims foreign priority benefit to Eurasian application No 201300133 filed Dec. 24, 2013, which is hereby incorporated by reference in its entirety.

### FIELD OF THE INVENTION

The invention relates to a device for measuring a thickness of ferromagnetic metal objects; more particularly, to a device for measuring a thickness of ferromagnetic objects using electromagnetic field.

### BACKGROUND OF THE INVENTION

Measuring a thickness of objects is essential for many applications. In case an object is accessible for measurements, the direct measurements can be made directly without difficulty; on the contrary, measuring extended objects (for example, sheets of material having edges inaccessible for measurements, or closed objects such as pipe walls) may often get complicated and only indirect measurements can be performed.

Numerous methods and devices are available for indirect thickness measurement, with various principles underlying their operation.

Thus, widely available are acoustic thickness gauges, which excite an acoustic wave in an object being measured and then analyze various parameters of the acoustic wave to determine the thickness.

In general, acoustic gauges measure the transmission time of the acoustic wave reflected from an interface between the object and the air. The transmission time data is then used to determine the wall thickness of the object, for example, using reference data on the speed of acoustic wave propagating through the object's material.

More complicated acoustic gauges are used to improve measurement accuracy. However, such complexity may be a drawback of the acoustic gauges and corresponding measurement methods. In particular, such acoustic methods, firstly, require that a couplant medium be disposed between the workpiece and the transducer to provide acoustic communication therebetween, and, secondly, demand that transmitting supersonic wave be provided along the transmission path both with and without the object disposed in the path.

Magnetic or electromagnetic fields applied to excite the acoustic wave make it possible to execute thickness measurements without a couplant medium being disposed between a measuring means and an object measured, which makes the measurements simpler.

However, it is essential to note that, according to such methods, in order to generate a uniform saturated magnetic field of a required strength, a coil having sufficient quantity of windings should be utilized, which means that a complicated device layout has to be used. Besides, a significant amount of energy is required to generate the saturated magnetic field of sufficient strength. Finally, the resultant reading of the wall thickness is averaged over the area covered by the coil. Therefore, local variations in the wall thickness may remain undetected.

### SUMMARY OF THE INVENTION

The object of the present invention is to provide a measuring device for measuring a thickness of ferromagnetic metallic objects, which provides an easy measurement method and a considerable coverage of the surface of the ferromagnetic metal object by the measuring device.

The object is achieved by a measuring device for measuring a thickness of a ferromagnetic metallic object, said device comprising at least two measurement sensors, each of the measurement sensors comprising a core that forms a closed magnetic circuit in combination with at least a part of the ferromagnetic metal object; and a core coil in which a current pulse is formed; wherein the measuring device further comprises a determination unit for determining the time constant of an exponential voltage pulse formed in the coil as a result of forming said current pulse, and an electronic unit which is coupled to each of the measurement sensors and which controls said sensors.

The technical result of the present invention provides reduction in measurement time when measuring a thickness of a ferromagnetic metal object in cases where said thickness must be determined over a relatively large portion.

Said technical result is achieved by a larger coverage of the measured object when the device comprises at least two sensors, and by the fact that the use of the disclosed device does not require stopping the measurement process in the event of a failure in at least one sensor if at least one other sensor is still operable, which further reduces measurement time in contingency situations.

Preferably, the measuring device comprises a spacer coupled to the measurement sensors and a spacer drive that drives the spacer to move the measurement sensors from an idle position into an operative position or from an operative position into an idle position.

Preferably, the measuring device comprises sixteen measurement sensors placed along the inner circumference of a ferromagnetic metal pipeline. The embodiment comprising a structure formed as a circle comprising sixteen measurement sensors provides the most effective measurement of a thickness of a pipeline with a 360° round cross-section. Said number of sensors provides control efficiency of at least 40 m/hour.

In another embodiment, each of the measurement sensors further comprises a gap measurement sensor for measuring the distance between the measurement sensor and the ferromagnetic metal object. In yet another embodiment, the magnetic gap sensor is coupled to the core of the corresponding measurement sensor by means of epoxy resin.

In yet another embodiment, the electronic unit is coupled to the spacer drive in order to control the spacer drive. In one embodiment, the determination unit comprises at least one electronic circuit board of said electronic unit.

### BRIEF DESCRIPTION OF THE DRAWINGS

A preferred embodiment of the invention is further discussed in detail with reference to accompanying drawings. The summary of the accompanying drawings follows.

FIG. 1 shows the arrangement and external view of primary elements of the measuring device in accordance with an embodiment of the invention;

FIG. 2 shows the spacer and the spacer drive in accordance with an embodiment of the invention;

FIG. 3 shows the measurement sensor in accordance with an embodiment of the invention;

FIG. 4 shows the electronic unit in accordance with an embodiment of the invention.

### PREFERRED EMBODIMENT OF THE INVENTION

The present invention is further explained in the following detailed description of a preferred embodiment with reference to accompanying drawings; similar reference numerals in the drawings refer to similar elements.

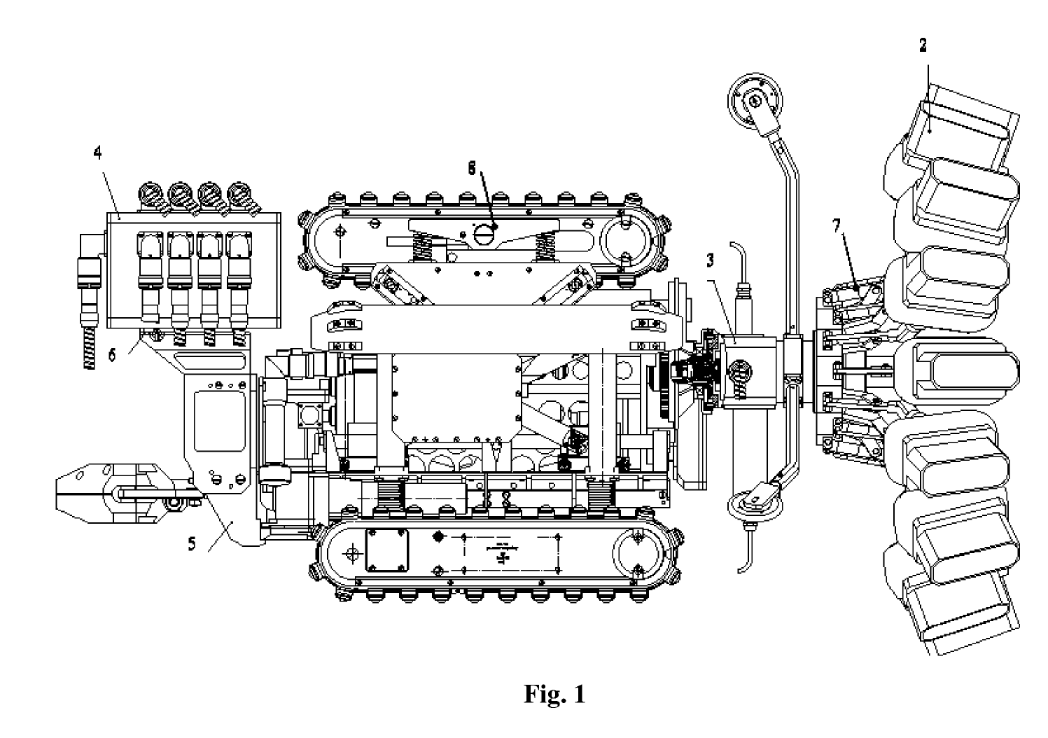

FIG. 1 shows the arrangement and external view of primary elements of the measuring device for measuring a thickness of a ferromagnetic metal object adapted to measure pipeline thickness according to an embodiment of the invention. According to the present embodiment, the measuring device (1) comprises at least the measurement sensors (2) and an electronic unit (4). Furthermore, the measuring device comprises blast-resistant delivery means (8) configured for delivering the measuring device to a measurement site. Preferably, delivery means (8) are formed by a creeper truck provided with a platform. In a particular embodiment, delivery means (8) comprise an upper platform and a lower platform with the truck coupled thereto. When the lower trucks rotate at the same speed, the delivery means (8) are displaced linearly. When the trucks rotate at different speeds (or in different directions), the delivery means (8) are rotated with a near-circular trajectory. In other embodiments, any other suitable delivery means can be used. A rotation joint (not shown) configured to rotate the measurement sensor unit about the longitudinal axis of the object by means fo a rotation joint motor (not shown) is mounted on the delivery means, in particular, on the upper platform. Preferably, the delivery means (8) have the following characteristics: delivery means (8) movement speed is at least 50 mm/s; maximum rotation velocity of the rotation joint is at least 6 rpm. The sensor unit comprises sixteen measurement sensors (2). It must be noted that, depending on the embodiment of the measuring device and configuration of the measured object, a different number of sensors can be used as long as at least two sensors are used.

Preferably, the measuring device for measuring object thickness has the following characteristics: pipeline wall thickness measurement range is 1 to 8 mm; pipeline wall thickness relative measurement error is ±10% or less; control efficiency is at least 40 m/hour.

Furthermore, in order to compensate for the mass of measuring device, a weight (not shown) is mounted on a support (5) attached to the lower platform.

A plate (6) with the electronic unit (4) attached thereto is mounted on the weight.

Furthermore, the measuring device comprises a spacer (7) with measurement sensors (2) attached to the elements thereof, and a spacer (7) drive (3) attached to the rotation joint and configured to move the spacer (7) from a folded position into an expanded position and vice versa in order to move measurement sensors from an idle position into an operative position and from an operative position into an idle position, respectively. The spacer (7) drive (3) is operated by means of the electronic unit (4).

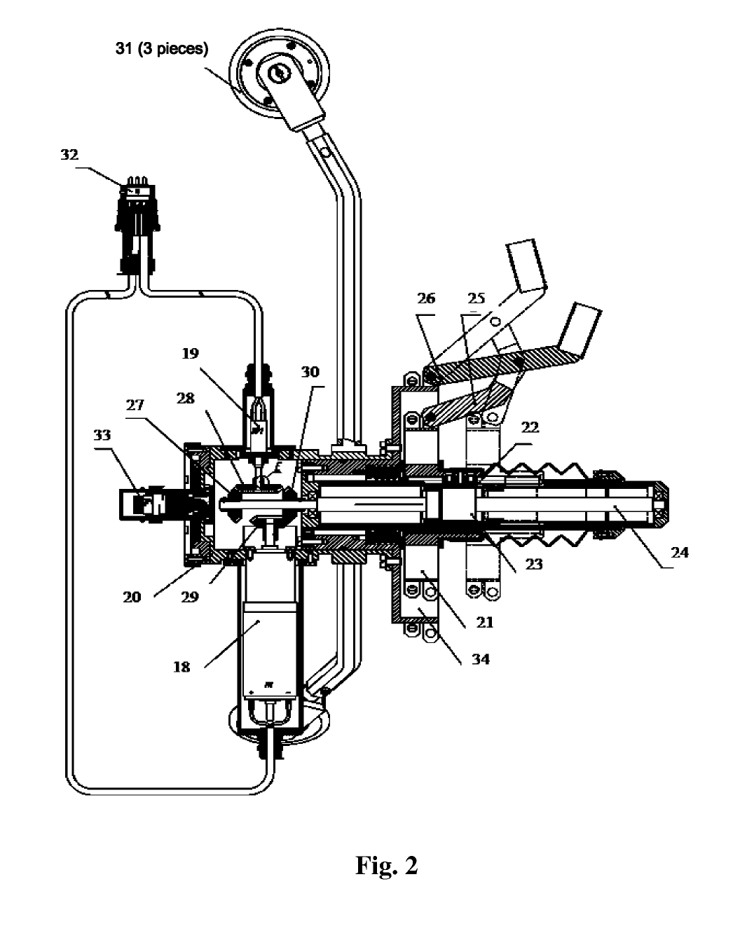

Structure of the spacer (7) drive (3) is shown in FIG. 2.

Rotation is translated from the motor (18) of the spacer (7) drive (3) controlled using the electronic unit (4) through gearwheels (29), (30) to a screw (24) of a ball-screw assembly which moves a nut (23) with a slide (22) mounted thereon. The slide (22) is fixedly coupled to a disc (21) of the drive (3) by means of screws (not shown); sixteen lower levers (25) of the spacer (7) are attached to said disc (21) by means of a hinge joint. The lower levers are evenly spaced along the circumference of the drive disc. Sixteen upper levers (26) of the spacer (7) are mounted on a support disc (34) by means of a hinge joint. Each of the measurement sensors (2) is mounted on the corresponding upper lever of the spacer.

When the slide (22) of the spacer drive is extended, the lower levers (25) engage the upper levers (26), pushing them upwards and thus pressing measurement sensors (2) against pipeline surface, thus expanding the spacer and moving sensors into an operative position. In turn, when the slide is retracted back to the original position, the spacer is folded and the sensors are moved from an operative position into an idle position. The even spacing of lower levers along the periphery of the drive disc provides even distribution of sensors along the inner circumference of the pipeline, and a part of the pipeline is thus enclosed in a ring.

In order to determine distance traveled by the slide (22) during extension thereof, an extension sensor (19) is used. Rotation is translated from the screw (24) to the gearwheel (28) mounted on the extension sensor (19) shaft through the gearwheel (27).

In order to provide stability during movement within the object, three bars with support rollers (31) (e.g., three rollers) are fixedly mounted on the body (20) of the spacer (7) drive (3). Sockets (32) and (33) are used for connecting the spacer (7) drive (3) (in particular, for connecting motor (18) and the extension sensor (19)) to the electronic unit (4) and for connecting the spacer (7) drive (3) to the rotation joint, respectively.

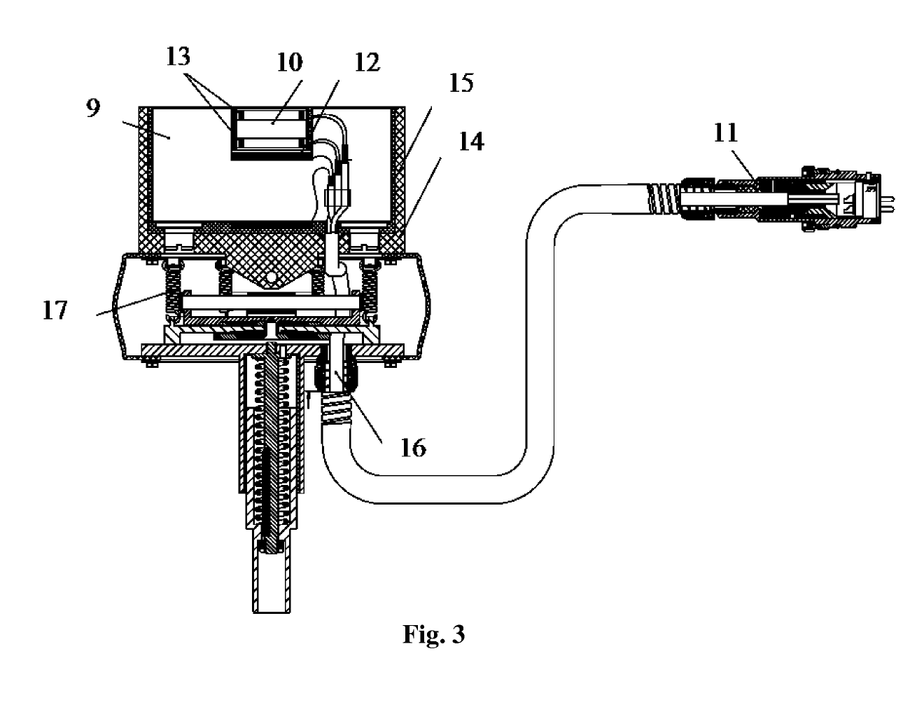

Structure of the measurement sensor is shown in FIG. 3.

The measurement sensor (2) comprises a thickness measurement sensor formed by a U-shaped ferrite core (9) with a coil (12).

Furthermore, a sensor (10) for measuring the gap between the core (9) and the object is provided in the gap of the measurement sensor (2). Gap measurement sensor (10) is formed by a plastic cylinder with a coil (13).

Gap measurement sensor (10) is connected to the core (9) of the measurement sensor (2) by means of epoxy resin, and both said sensors are received in a plastic body (14) and embedded in polyurethane (15). Measurement range of the gap between the measurement sensor (2) and the object surface preferably ranges from 0 to 10 mm.

Two twisted pairs extending from coils (12, 13) of the sensors (2, 10) are joined into one cable (16). A connector (11) for coupling to the electronic unit (4) is soldered at the end of cable (16). Springs (17) securely press the measurement sensor against the object surface.

Furthermore, the measuring device further comprises a current source (not shown) coupled to the coil (12) and determination unit coupled to the coil (12) and used for determining at least one parameter of an exponential voltage pulse, e.g. the time constant thereof, and for determining object thickness based on said time constant of the exponential voltage pulse.

The magnetic circuit formed by the core (9) with the coil (12) and the object comprises 4 sections: the first section of the magnetic circuit corresponds to the core (9) with the coil (12), the second section of the magnetic circuit corresponds to the object, the third and fourth sections of the magnetic circuit correspond to the gap between the core (9) and the object. H1 and B1 are intensity and induction of the magnetic field in the core (9), H2 and B2 are intensity and induction of the magnetic field directly in the object, and H_{B} and B_{B} are intensity and induction of the magnetic field in air-filled gaps between the core (9) and the object.

According to Ampere's circuital law for a magnetic circuit

H1·L1+H_{B}·δ+H2·L2+H_{B}·δ=I·N,

where L1 is length of the first section, L2 is length of the second section, δ is length of the third and fourth sections, I is complex current amplitude in the coil (12) of the core (9), and N is the quantity of windings in the coil (12) of the core (9). In this particular embodiment of the invention, core height is 90 mm and core length is 100 mm.

To simplify calculations, assume that the field is entirely within the closed magnetic circuit and said circuit has no branching; therefore, it can be considered that

φ1=φ2=φ_{B}−φ,

where φ1 is magnetic induction flux in the core (9), φ2 is magnetic induction flux in the object,
φB is magnetic induction flux in air-filled gaps between the core (9) and the object, and φ is total flux in the magnetic circuit.

Taking into account that φ1=B1·S1, φ2=B2·h·b, φ_{B}≈B_{B}·S1,

where S1 is area of the contour corresponding to the area of a portion of the core (9) and air-filled gaps with magnetic induction fluxes φ1 and φ_{B} passing therethrough (in this embodiment, the core has a rectangular cross-section, but it can also have a circular cross-section, square cross-section or cross-section of any other shape), h is a thickness of the metal object, and b is overall size of the core (9) (e.g., 34 mm),

and further taking into account that H1=B1/μ1·μ0, H2=B2/μ2·μ0, H_{B}=B_{B}/μ0, where μ0 is space permeability, μ1 is permeability coefficient of the core (9), and μ2 is permeability coefficient of the object, the above equations can be used to express the magnetic induction flux value

$$Φ = \frac{I \cdot N}{\frac{L 1}{{μ}_{0} \cdot {μ}_{1} \cdot a \cdot b} + \frac{2 δ}{{μ}_{0} \cdot a \cdot b} + \frac{L 2}{{μ}_{0} \cdot {μ}_{2} \cdot b \cdot h}}$$

Permeability coefficients can be obtained from literature or determined in practice using corresponding means.

Considering that inductance L is, by definition, the ratio of flux linkage to current

L=φ·N/I,

inductance of the core (9) placed above the object can be expressed as

$$L = \frac{{N}^{2}}{\frac{L 1}{{μ}_{0} \cdot {μ}_{1} \cdot a \cdot b} + \frac{2 δ}{{μ}_{0} \cdot a \cdot b} + \frac{L 2}{{μ}_{0} \cdot {μ}_{2} \cdot b \cdot h}}$$

where a is another overall size of the core (9) (e.g., 34 mm).

Voltage time constant at the core (9), when the gap between the core (9) and the object is small, is equal to the ratio of core (9) inductance to object resistance, i.e.

T=L/R,

where R is resistance of the object.

Preferably, the gap between the core (9) and the object is identical at both sections of the magnetic circuit and can be within the range, e.g., from 1 mm to 10 mm.

Object resistance can be expressed as

R=L2·ρ/(b·h),

where ρ is specific resistance of the object material.

Based on the three previous equations, the time constant can be expressed as

$$τ = \frac{{N}^{2} \cdot b \cdot \frac{h}{ρ}}{( \frac{L 1}{{μ}_{0} \cdot {μ}_{1} \cdot a \cdot b} + \frac{2 δ}{{μ}_{0} \cdot a \cdot b} + \frac{L 2}{{μ}_{0} \cdot {μ}_{2} \cdot b \cdot h} ) \cdot L 2}$$

The overall size of the core (9) is selected so that for h>1 mm, the following inequation is valid:

$$\frac{L 1}{{μ}_{0} \cdot {μ}_{1} \cdot a \cdot b} + \frac{2 δ}{{μ}_{0} \cdot a \cdot b} > \frac{L 2}{{μ}_{0} \cdot {μ}_{2} \cdot b \cdot h}$$

Therefore, it can be considered that

$$τ = \frac{{N}^{2} \cdot b \cdot \frac{h}{ρ}}{( \frac{L 1}{{μ}_{0} \cdot {μ}_{1} \cdot a \cdot b} + \frac{2 δ}{{μ}_{0} \cdot a \cdot b} ) \cdot L 2}$$

$$h = \frac{ρ \cdot τ \cdot L 2 \cdot ( \frac{L 1}{{μ}_{0} \cdot {μ}_{1} \cdot a \cdot b} + \frac{2 δ}{{μ}_{0} \cdot a \cdot b} )}{{N}^{2} \cdot b}$$

The last expression shows that the measured thickness of the object is proportional to the time constant of an exponential voltage pulse at the core (9).

In particular, the determination unit for determining object thickness can determine object thickness based on the above expression recorded in their memory. Furthermore, determination unit can comprise more than one expression for determining object thickness in their memory; e.g. they can comprise expressions for determining relative positions of the object and the core (9). According to one embodiment, the determination unit comprises time constant determination unit (not shown) for determining time constant of an exponential voltage pulse and object thickness determination unit (not shown) for determining thickness of the inspected object based on the time constant of the exponential voltage pulse. In one embodiment, the determination unit is integrated into the electronic unit (4) in the form of corresponding electronic circuit boards (not shown).

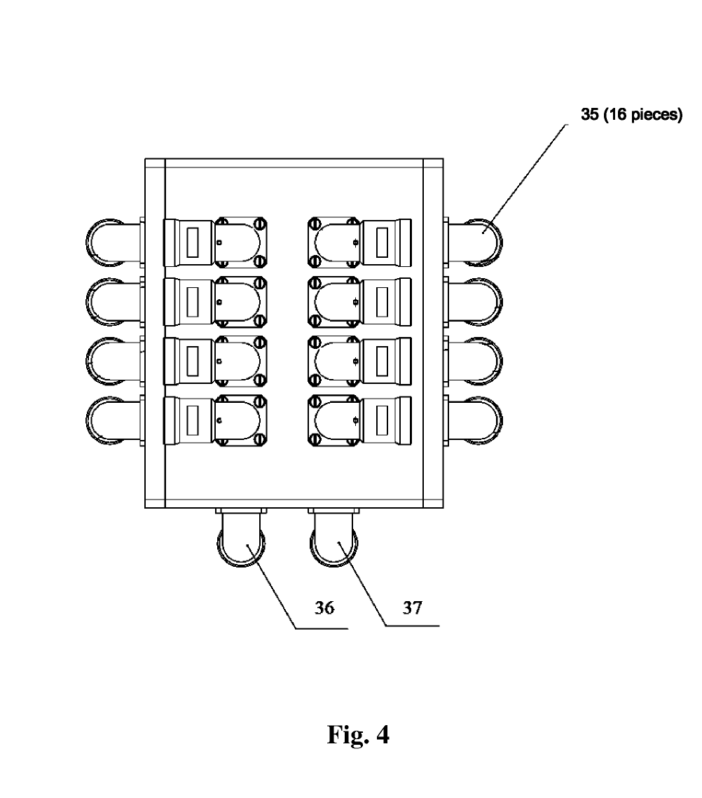

The electronic unit (4) is configured to control measurement sensors (2). Structure of the electronic unit (4) is shown in FIG. 4.

The electronic unit (4) consists of the following primary units:
a circuit board unit:
a power unit;
a thickness gauge unit;
a socket (35) for connecting the measurement sensor (2);
a socket (36) for connecting the spacer (7) drive (3), in particular, for connecting the motor (18) and the extension sensor (19);
a socket (37) for connecting the electronic unit power cable.

In an embodiment of the measuring device (1) comprising sixteen measurement sensors (2), the electronic unit comprises sixteen sockets (35) for connecting the measurement sensor (2), so that each of the sensors is connected to the corresponding socket. Therefore, in an embodiment of the measuring device (1) comprising any other number of measurement sensors (2) larger than one, the electronic unit comprises a corresponding number of sockets (35) for connecting the measurement sensor (2).

The power unit is configured to generate direct current for powering circuit boards.

The thickness gauge unit is configured to generate, receive and process measurement signals.

All sockets of the electronic unit (4) can be marked accordingly in order to simplify the process of connecting the electronic unit (4), measurement sensors and the spacer (7) drive (3).

Prior to commencing measurement, the measurement sensors (2) are in an idle position, i.e., they are not pressed against the object surface. The measurement sensors (2) are moved into an operative position by means of the spacer (7) drive (3) by pressing the measurement sensors (2) against the object surface.

Measurements are taken simultaneously with all measurement sensors in sixteen areas along the inner circumference of the pipeline surface with the coverage angle of 360°, thus providing simultaneous thickness measurement in sixteen areas of the pipeline portion forming a ring, wherein ring width is defined by sensor size in longitudinal direction of the pipeline. After completing measurements in one part of the pipeline using said ring-shaped arrangement, the measurement sensors (2) are moved into an idle position by means of the spacer (7) drive (3), and the delivery means (8) are moved along the pipeline by a distance of one scanning step in order to perform measurements in the next part of the pipeline using said ring-shaped arrangement. The scanning step (the distance between rings) can be, e.g., 225 mm.

When measuring a thickness, each of the measurement sensors (2) provides an averaged thickness value under the aperture. The electronic unit (4) receives a separate signal from each individual measuring sensor (2). This allows to determine the condition of each sensor. Thus, when at least one sensor fails, if at least one other sensor is still operable, the use of rotation joint configured to rotate the measuring sensor unit about the longitudinal axis of the object ensures that there is no need to stop the measurement process.

The measurement sensors (2) comprise a pressing force compensation mechanism, e.g., a spring that eliminates error caused by positioning the delivery means (8) with respect to the object axis and by uneven pressing of the sensors against the object.

Object thickness is measured as follows.

A current pulse of a certain amplitude and certain length is formed in the coil (12) of the core (9) by means of the current source. Useful signal value depends on the current pulse amplitude: the greater the amplitude, the greater the useful signal value; however, when the amplitude is exceedingly high, the core (9) can be saturated. The amplitude can be, e.g. in the range of 300-400 mA. Impulse length can be selected based on core (9) thickness. The impulse length can be, e.g, 1 second.

After the current pulse falls on the ends of the coil (12), an exponential voltage pulse is formed. Then the time constant of the exponential voltage pulse is determined using determination unit. The time constant of the exponential voltage pulse is proportional to the resistance of object volume under the core (9) with the coil (12), which is, in turn, proportional to object thickness.

Therefore, by measuring the time constant of the exponential voltage pulse at the core (9) with the coil (12), object thickness can be determined based on said time constant.

Measurement results can be displayed on a display device (not shown).

The description hereinabove is exemplary and should not be considered limiting. Variations and modifications of the disclosed embodiments without departing from the scope of the present invention will be apparent to those skilled in the art. The embodiment comprising a circular structure comprising sixteen measurement sensors, which is especially effective for measuring a thickness of a pipeline with a circular cross-section, is purely exemplary and should not be considered limiting. It will be apparent to those skilled in the art that in addition to a thickness of a pipeline with a circular cross-section, thicknesses of objects having different shapes and cross sections can be measured, and the disclosed measuring device can comprise a different number of sensors (larger than one) for expedited measurement of a thickness of an object having a corresponding different shape and cross section. For example, when measuring a thickness of a flat object, four sensors can be used, and the sensors can be arranged in a square configuration in order to increase area coverage of the measured object.

All distances, sizes and numerical values provided in the present description are purely exemplary and are not intended to limit the present invention, and possible error values thereof can be simulated and eliminated programmatically.

1. A measuring device for measuring a thickness of a ferromagnetic metal object, the device comprising:
at least two measurement sensors, each of the measurement sensors comprising
a core that forms a closed magnetic circuit in combination with at least a part of the ferromagnetic metal object, and
a core coil in which a current pulse is formed; wherein the measuring device further comprises
a determination unit for determining the time constant of an exponential voltage pulse formed in the coil as a result of forming said current pulse, and
an electronic unit which is coupled to each of the measurement sensors and which controls said sensors.

2. The device according to claim 1, further comprising a spacer coupled to said measurement sensors and a spacer drive that drives the spacer to move the measurement sensors from an idle position into an operative position or from an operative position into an idle position.

3. The device according to claim 1, wherein each of the measurement sensors further comprises a gap measurement sensor for measuring the distance between the measurement sensor and the ferromagnetic metal object.

4. The device according to claim 1, wherein the magnetic gap sensor is coupled to the core of the corresponding measurement sensor by means of epoxy resin.

5. The device according to claim 1, wherein the number of measurement sensors is sixteen.

6. The device according to claim 5, wherein said sixteen measurement sensors are placed along the inner circumference of a ferromagnetic metal pipeline.

7. The device according to claim 2, wherein the electronic unit is coupled to the spacer drive in order to control the spacer drive.

8. The device according to claim 1, wherein the determination unit comprises at least one electronic circuit board of said electronic unit.
